(19) United States
(12) Patent Application Publication
(10) Pub. No.: US 2026/0146944 A1
(43) Pub. Date: May 28, 2026

(54) THIN FILM CHARACTERISTIC DIAGNOSIS DEVICE AND THIN FILM CHARACTERISTIC DIAGNOSIS METHOD

(71) Applicant: INDUSTRY-ACADEMIC COOPERATION FOUNDATION, YONSEI UNIVERSITY, Seoul (KR)

(72) Inventors: Jong Chan KIM, Seoul (KR); Dong Hyeon SHIN, Seoul (KR); Seung Yeon CHO, Seoul (KR)

(21) Appl. No.: 19/395,561

(22) Filed: Nov. 20, 2025

(30) Foreign Application Priority Data
Nov. 22, 2024 (KR) 10-2024-0168814

(51) Int. Cl. G01N 21/41

(52) U.S. Cl. CPC G01N 21/4133; G01N 2021/4126; G01N 2201/06113

(57) ABSTRACT

A thin film characteristic diagnosis device according to an embodiment includes: a memory storing at least one instruction; and at least one processor executing the at least one instruction, wherein the at least one processor is configured to: make laser (light amplification by simulated emission of radiation; LASER) light, which supplies energy to a thin film, be incident onto the thin film; determine an ordinary refractive index (nₒ) of the thin film based on a first spectrum obtained by polarizing emission light that has passed through a Fourier lens after being emitted from the thin film according to a first polarization plane; and determine a transition dipole moment (TDM) orientation angle (θₕₒᵣ) and an extraordinary refractive index (nₑ) of the thin film based on the first spectrum and a second spectrum obtained by polarizing the emission light according to a second polarization plane perpendicular to the first polarization plane.

### CROSS REFERENCE TO RELATED APPLICATION

The present application claims priority to Korean Patent Application 10-2024-0168814, filed Nov. 22, 2024, the entire contents of which are incorporated here for all purposes by this reference.

### BACKGROUND

The disclosure relates to a thin film characteristic diagnosis device and a thin film characteristic diagnosis method.

With the advancement of technology, the integration of displays into complex optical systems for implementing extended reality (XR) devices is becoming increasingly necessary, and the growing need for outdoor visibility is driving the development of technologies to enhance display brightness. To enhance the external quantum efficiency associated with display brightness, there is a need to improve outcoupling efficiency. To improve outcoupling efficiency, research is being conducted to reduce the resources required for sensing the refractive index of display components and the orientation of the transition dipole moment (TDM) of the components, while also improving accuracy.

This work was supported by the Technology Innovation Program (RS-2025-02653941) through the Korea Planning & Evaluation Institute of Industrial Technology (KEIT) funded by the Ministry of Trade, Industry & Energy (MOTIE, Korea), and Korea Institute for Advancement of Technology (KIAT) grant funded by the Korean Government (MOTIE) (RS-2025-02263458), and Industrial Strategic Technology Development Program (2410011147) funded by the Korean Ministry of Trade, Industry & Energy (MOTIE), and Global-Learning & Academic research institution for Master's PhD students, and Postdocs (LAMP) Program of the National Research Foundation of Korea (NRF) grant funded by the Ministry of Education (RS-2024-00442483), and LG Display under the LGD-Yonsei Incubation Program, Award Number C2024001801, and National Research Foundation of Korea (NRF) grant funded by the Korea government (Ministry of Science and ICT) (RS-2025-24535263).

### SUMMARY

According to embodiments disclosed in the present document, provided are a thin film characteristic diagnosis device and a thin film characteristic diagnosis method that improve the accuracy of a measured refractive index and the accuracy of an orientation of a measured transition dipole moment (TDM).

Furthermore, according to embodiments disclosed in the present document, provided are a thin film characteristic diagnosis device and a thin film characteristic diagnosis method that reduce the time required to measure a refractive index and an orientation of a TDM.

The aspect of the disclosure is not limited to that mentioned above, and other aspects not mentioned will be clearly understood by those skilled in the art from the description below.

A thin film characteristic diagnosis device according to an embodiment disclosed in the present document may include a memory storing at least one instruction, and at least one processor executing the at least one instruction.

According to an embodiment, by executing the at least one instruction, the at least one processor may make laser (light amplification by simulated emission of radiation; LASER) light, which supplies energy to a thin film, be incident onto the thin film, determine an ordinary refractive index (nₒ) of the thin film based on a first spectrum obtained by polarizing emission light that has passed through a Fourier lens after being emitted from the thin film according to a first polarization plane, and determine a transition dipole moment (TDM) orientation angle (θₕₒᵣ) and an extraordinary refractive index (nₑ) of the thin film based on the first spectrum and a second spectrum obtained by polarizing the emission light according to a second polarization plane perpendicular to the first polarization plane.

According to an embodiment, the at least one processor may convert the first spectrum into a first image through an image sensor, determine the ordinary refractive index (nₒ) of the thin film based on an intensity distribution according to an angle identified based on the first image, convert the second spectrum into a second image through the image sensor, and determine a TDM orientation angle (θₕₒᵣ) and an extraordinary refractive index (nₑ) of the thin film based on an intensity distribution according to an angle identified based on the second image and an intensity distribution according to an angle identified based on the first image.

According to an embodiment, the determining of the ordinary refractive index (nₒ) may include setting up, through simulation, multiple simulation thin films each having a different ordinary refractive index (nₒ),
obtaining respective first simulation images, each of which is converted from a first simulation spectrum in which simulated emission light that has passed through a Fourier lens after being emitted from each of the simulation thin films is polarized according to the first polarization plane,
obtaining ordinary refractive index (nₒ) errors by comparing the first image with each of the first simulation images, and
determining, as the ordinary refractive index (nₒ), a value that minimizes the ordinary refractive index (nₒ) error; and
the determining of the TDM orientation angle (θₕₒᵣ) and extraordinary refractive index (nₑ) may include
setting the determined ordinary refractive index (nₒ) to a fixed value,
setting, through simulation, multiple simulation thin films each having a different combination of a TDM orientation angle (θₕₒᵣ) and an extraordinary refractive index (nₑ),
obtaining second simulation images, each of which is converted from a second simulation spectrum in which simulated emission light that has passed through a Fourier lens after being emitted from each of the simulation thin films is polarized according to the second polarization plane,
simultaneously obtaining the TDM orientation angles (θₕₒᵣ) and extraordinary refractive index (nₑ) errors by comparing the second image with each of the second simulation images, and
simultaneously determining the TDM orientation angle (θₕₒᵣ) and extraordinary refractive index (nₑ) by a combination that minimizes the sum of the TDM orientation angles (θₕₒᵣ) and extraordinary refractive index (nₑ) errors.

According to an embodiment, the emission light, after being emitted from the thin film, may passe through a filtering filter that filters the laser light reflected from the thin film before passing through the Fourier lens.

According to an embodiment, the emission light, after being emitted from the thin film, may pass through a neutral density (ND) filter that reduces the intensity of the emission light before passing through the Fourier lens.

A thin film characteristic diagnosis method according to another embodiment disclosed in the present document may include:
making laser (light amplification by simulated emission of radiation; LASER) light, which supplies energy to a thin film, be incident onto the thin film; determining an ordinary refractive index (nₒ) of the thin film based on a first spectrum obtained by polarizing emission light that has passed through a Fourier lens after being emitted from the thin film according to a first polarization plane; and determining a transition dipole moment (TDM) orientation angle (θₕₒᵣ) and an extraordinary refractive index (nₑ) of the thin film based on the first spectrum and a second spectrum obtained by polarizing the emission light according to a second polarization plane perpendicular to the first polarization plane.

According to an embodiment, the determining of the ordinary refractive index (nₒ) may include converting the first spectrum into a first image through an image sensor, and determining the ordinary refractive index (nₒ) of the thin film based on an intensity distribution according to an angle identified based on the first image; and the determining of the TDM orientation angle (θₕₒᵣ) and extraordinary refractive index (nₑ) may include converting the second spectrum into a second image through the image sensor, and determining a TDM orientation angle (θₕₒᵣ) and an extraordinary refractive index (nₑ) of the thin film based on an intensity distribution according to an angle identified based on the second image and an intensity distribution according to an angle identified based on the first image.

According to an embodiment, the determining of the ordinary refractive index (nₒ) may include setting up, through simulation, multiple simulation thin films each having a different ordinary refractive index (nₒ); obtaining respective first simulation images, each of which is converted from a first simulation spectrum in which simulated emission light that has passed through a Fourier lens after being emitted from each of the simulation thin films is polarized according to the first polarization plane; obtaining ordinary refractive index (nₒ) errors by comparing the first image with each of the first simulation images; and determining, as the ordinary refractive index (nₒ), a value that minimizes the ordinary refractive index (nₒ) error, and the determining of the TDM orientation angle (θₕₒᵣ) and extraordinary refractive index (nₑ) may include:
setting the determined ordinary refractive index (nₒ) to a fixed value; setting, through simulation, multiple simulation thin films each having a different combination of a TDM orientation angle (θₕₒᵣ) and an extraordinary refractive index (nₑ); obtaining second simulation images, each of which is converted from a second simulation spectrum in which simulated emission light that has passed through a Fourier lens after being emitted from each of the simulation thin films is polarized according to the second polarization plane; simultaneously obtaining the TDM orientation angles (θₕₒᵣ) and extraordinary refractive index (nₑ) errors by comparing the second image with each of the second simulation images; and simultaneously determining the TDM orientation angle (θₕₒᵣ) and extraordinary refractive index (nₑ) by a combination that minimizes the sum of the TDM orientation angles (θₕₒᵣ) and extraordinary refractive index (nₑ) errors.

According to an embodiment, the emission light, after being emitted from the thin film, may passe through a filtering filter that filters the laser light reflected from the thin film before passing through the Fourier lens.

According to an embodiment, the emission light, after being emitted from the thin film, may pass through a neutral density (ND) filter that reduces the intensity of the emission light before passing through the Fourier lens.

This technology can improve the accuracy of a measured refractive index and the accuracy of a measured transition dipole moment (TDM) orientation.

Furthermore, this technology can reduce the time required to measure a refractive index and a TDM orientation angle.

In addition, various effects, grasped either directly or indirectly through the present document, can be provided.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating the configuration of a thin film characteristic diagnosis device in a thin film characteristic diagnosis device and thin film characteristic diagnosis method according to an embodiment of the present document;

FIG. 2 illustrates an example of the structure of a thin film characteristic diagnosis device in a thin film characteristic diagnosis device and thin film characteristic diagnosis method according to an embodiment of the present document;

FIG. 3 illustrates examples of a first polarization plane and second polarization plane in a thin film characteristic diagnosis device and thin film characteristic diagnosis method according to an embodiment of the present document;

FIG. 4 illustrates an example of a polarized Fourier plane image in a thin film characteristic diagnosis device and thin film characteristic diagnosis method according to an embodiment of the present document;

FIG. 5 illustrates an example of the flow of operations of a thin film characteristic diagnosis device that determines a refractive index and an angle at which a TDM is positioned in a thin film characteristic diagnosis device and thin film characteristic diagnosis method according to an embodiment of the present document;

FIG. 6 illustrates the influence of a typical refractive index (n) in a monorefractive (isotropic) material without birefringence (nₒ, nₑ) in a thin film characteristic diagnosis device and thin film characteristic diagnosis method according to an embodiment of the present document, wherein shown are examples of graphs showing an intensity distribution in a first polarization plane and an intensity distribution in a second polarization plane according to the refractive indices of a thin film;

FIG. 7 illustrates examples of graphs showing an intensity distribution in a first polarization plane and an intensity distribution in a second polarization plane according to angles at which a TDM is positioned in a thin film characteristic diagnosis device and thin film characteristic diagnosis method according to an embodiment of the present document;

FIG. 8 illustrates examples of diagrams showing the sum of the refractive index error and the TDM error corresponding to the refractive index error, depending on the refractive indices and the angles at which a TDM is positioned, in a thin film characteristic diagnosis device and thin film characteristic diagnosis method according to an embodiment of the present document;

FIG. 9 illustrates the influence of each refractive index in a birefringent (nₒ, nₑ) material in a thin film characteristic diagnosis device and thin film characteristic diagnosis method according to an embodiment of the present document, wherein a of FIG. 9 is a graph depicting a k-space emission intensity distribution according to the variation of an ordinary refractive index (nₒ), and b of FIG. 9 is a graph depicting a k-space emission intensity distribution according to the variation of an extraordinary refractive index (nₑ);

FIG. 10 illustrates the structure of an organic halide perovskite (OHP) film constituting a thin film in a thin film characteristic diagnosis device and thin film characteristic diagnosis method according to an embodiment of the present document;

FIG. 11 illustrates examples of a Fourier plane image based on a first spectrum and a first simulation spectrum, and a Fourier plane image based on a second spectrum and a second simulation spectrum, in a thin film characteristic diagnosis device and thin film characteristic diagnosis method according to an embodiment of the present document;

FIG. 12 illustrates an example graph showing an intensity distribution in a first polarization plane and an intensity distribution in a second polarization plane of an organic halide perovskite (OHP) film in a thin film characteristic diagnosis device and thin film characteristic diagnosis method according to an embodiment of the present document; and

FIG. 13 illustrates an example diagram showing the sum of the refractive index error of an organic halide perovskite (OHP) film and a TDM error corresponding to the refractive index error in a thin film characteristic diagnosis device and thin film characteristic diagnosis method according to an embodiment of the present document.

### DETAILED DESCRIPTION

The disclosure is susceptible to various modifications and takes many forms, and thus specific embodiments are illustrated in the drawings and described in detail herein. However, this is not intended to limit the disclosure to a specific disclosed form, but rather to encompass all modifications, equivalents, and alternatives falling within the spirit and technical scope of the disclosure.

The terms are used for distinguishing one element from another. The terms used herein are used solely to describe specific embodiments and are not intended to limit the disclosure. The singular expression “singular” includes plural expressions unless the context clearly indicates otherwise.

Terms such as “include” or “consist of” in the disclosure indicate the presence of features, numbers, steps, operations, components, parts, or combinations thereof described in the specification, but should be understood not to preclude the presence or addition of one or more other features, numbers, steps, operations, components, parts, or combinations thereof. Furthermore, when a layer, film, region, or plate is said to be “on” another part, this includes not only the case where it is “directly above” the other part, but also the case where there is another part in between. Furthermore, in this specification, when a layer, film, region, or plate is said to be formed on another part, the direction in which it is formed is not limited to the upper direction, but also includes the case where it is formed in the lateral or lower direction. Conversely, when a layer, film, region, or plate is said to be “under” another part, this includes not only the case where it is “directly below” the other part, but also the case where there is another part in between.

In this specification, the terms “upper surface” and “lower surface” are used as relative concepts to facilitate the understanding of the technical concepts of the disclosure. Therefore, “upper surface” and “lower surface” do not refer to a specific direction, location, or component, and can be used interchangeably. For example, “upper surface” may be interpreted as “lower surface,” and “lower surface” may be interpreted as “upper surface.” Therefore, the “upper surface” can be expressed as “first” and the “lower surface” as “second,” or the “upper surface” can be expressed as “first” and the “lower surface” as “second.” However, within a single embodiment, the terms “upper surface” and “lower surface” are not interchangeable.

Unless otherwise defined, all terms used herein, including technical or scientific terms, have the same meaning as commonly understood by those of ordinary skill in the art to which the disclosure belongs. Terms defined in commonly used dictionaries should be interpreted as having a meaning consistent with their meaning in the context of the relevant technology, and unless explicitly defined in this application, they should not be interpreted in an idealized or overly formal sense.

Hereinafter, preferred embodiments of the present document will be described in more detail with reference to the attached drawings.

At this time, a thin film characteristic diagnosis device according to an embodiment of the present document and a thin film characteristic diagnosis method according to another embodiment have substantially the same technical configuration, and are described collectively, but each description can be applied to both the thin film characteristic diagnosis device and the thin film characteristic diagnosis method.

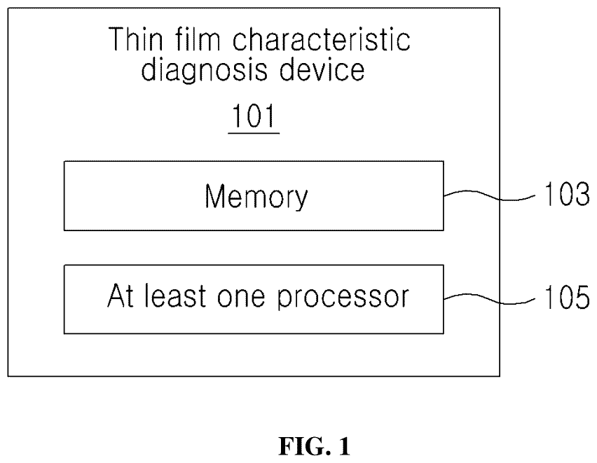

FIG. 1 is a block diagram illustrating the configuration of a thin film characteristic diagnosis device in a thin film characteristic diagnosis device and thin film characteristic diagnosis method according to an embodiment of the present document.

Referring to FIG. 1, the thin film characteristic diagnosis device may include memory (103) and at least one processor (105). The memory (103) may store at least one instruction. The at least one processor (105) may execute at least one instruction.

According to an embodiment, at least one processor (105) may make laser light (light amplification by simulated emission of radiation; LASER), which supplies energy to a thin film, be incident onto the thin film.

According to an embodiment, the thin film may absorb laser light emitted from a laser. In other words, the thin film may be optically pumped by absorbing the laser light. The emission light emitted by the thin film that has absorbed the laser light may pass through an objective lens, a filtering filter, a neutral density (ND) filter, and then a Fourier lens. The filtering filter may transmit the emission light emitted from the thin film and filter out the laser light emitted from the laser and reflected from the thin film. The neutral density filter may reduce the overall intensity of the emission light.

According to an embodiment, at least one processor (105) may determine an ordinary refractive index (nₒ) of the thin film based on a first spectrum obtained by polarizing emission light passing through a Fourier lens according to a first polarization plane.

The first polarization plane may be referred to as the s-polarization plane (sPP), but embodiments of the present disclosure may not be limited thereto.

According to an embodiment, at least one processor (105) may determine a transition dipole moment (TDM) orientation angle (θₕₒᵣ) and an extraordinary refractive index (nₑ) of the thin film based on a second spectrum obtained by polarizing emission light passing through a Fourier lens according to a second polarization plane perpendicular to the first polarization plane and the first spectrum (ordinary refractive index information).

The second polarization plane may be referred to as the p-polarization plane (pPP), but embodiments of the present document are not limited thereto.

The first polarization plane (sPP) pattern is determined solely by the ordinary refractive index (nₒ), unaffected by variations in the TDM orientation angle (θₕₒᵣ) and the extraordinary refractive index (nₑ).

Regarding the physical effects of birefringence and the principles of separation measurement, the angular distribution of light emitted from a thin film is determined by three fundamental factors, which are the film thickness, the TDM orientation, and the material's refractive index (typically nₒ and nₑ).

Furthermore, regarding the role of the s-polarization plane (sPP) pattern,

An emission pattern projected onto the sPP appears only when the TDM is aligned perpendicular to the incident plane and horizontal to the substrate plane.

Here, since the TDM is perpendicular to the optical axis, the ordinary refractive index (nₒ) dominates the optical response for all in-plane wave vectors (k_{∥}) and influences the overall sPP pattern.

Since the sPP pattern is only produced by the TDM aligned horizontally to the substrate plane, the horizontal alignment is not affected by θhor; furthermore, since electromagnetic waves parallel to the optical axis do not arrive, it is not affected by the extraordinary refractive index (nₑ).

Furthermore, regarding the role of the pattern in the p-polarization plane (pPP),

An emission pattern projected onto the pPP is produced by the TDM (horizontal and vertical components) located within the incident plane.

Here, when k_{∥}/k₀ is close to 0 (normal direction), the electric field is primarily aligned in the in-plane direction perpendicular to the optical axis, emission is primarily determined by nₒ;
as k_{∥}/k₀ increases, the out-of-plane component becomes more prominent, strengthening the influence of nₑ.

In particular, nₑ significantly modifies the pPP pattern in the high-k region (k_{∥}/k₀>1), where the out-of-plane electric field component parallel to the optical axis is maximized.

Variations in nₒ, nₑ, θₕₒᵣ each induce unique and quantifiable changes in the calculated sPP and pPP spectra.

Specifically, nₒ controls the overall sPP response by determining the in-plane electric field interaction;
nₑ reconfigures the pPP spectral profile in the high-k region by controlling the out-of-plane electric field component; and
θₕₒᵣ modulates the overall pPP intensity by controlling the coupling efficiency of the air mode or high-k mode of the TDM.

In the disclosure, by utilizing these unique spectral signals, nₒ is first determined by comparing the measured sPP emission pattern with the corresponding calculated result, and then
nₑ and θₕₒᵣ are determined by comparing the measured pPP pattern with the simulation.

This procedure allows for simultaneous determination of the TDM direction and the thin film refractive index.

Hereinafter, this will be described in more detail.

According to an embodiment, at least one processor (105) may use simulation to determine the refractive index.

For example, at least one processor (105) may convert the first spectrum into a first image via an image sensor (e.g., a charge-coupled device (CCD)).

At least one processor (105) may,
in determining the ordinary refractive index (nₒ),
set up, through simulation, multiple simulation thin films each having a different ordinary refractive index (nₒ), and
obtain respective first simulation images, each of which is converted from a first simulation spectrum in which simulated emission light that has passed through a Fourier lens after being emitted from each of the simulation thin films is polarized according to the first polarization plane.

At least one processor (105) may ordinary refractive index (nₒ) errors by comparing the first image with each of the first simulation images, and
determine, as the ordinary refractive index (nₒ), a value that minimizes the ordinary refractive index (nₒ) error.

In other words, at least one processor (105) may determine an optimal ordinary refractive index (nₒ) by comparing the first image with each of a plurality of first simulation images according to various ordinary refractive indices (nₒ).

The ordinary refractive index (nₒ) error may be expressed using the mean squared error (MSE), but the embodiments of the present disclosure may not be limited thereto.

According to an embodiment, at least one processor (105) may use simulation to determine the angle (θₕₒᵣ) at which the TDMs included in the thin film are arranged and the extraordinary refractive index (nₑ).

For example, at least one processor (105) may convert the second spectrum into a second image via an image sensor.

At least one processor (105) may, in determining the TDM orientation angle (θₕₒᵣ) and extraordinary refractive index (nₑ),
set the determined ordinary refractive index (nₒ) to a fixed value,
set, through simulation, multiple simulation thin films each having a different combination of a TDM orientation angle (θₕₒᵣ) and an extraordinary refractive index (nₑ), and
obtain second simulation images, each of which is converted from a second simulation spectrum in which simulated emission light that has passed through a Fourier lens after being emitted from each of the simulation thin films is polarized according to the second polarization plane.

At least one processor (105) may simultaneously obtain the TDM orientation angles (θₕₒᵣ) and extraordinary refractive index (nₑ) errors by comparing the second image with each of the second simulation images, and
simultaneously determine the TDM orientation angle (θₕₒᵣ) and extraordinary refractive index (nₑ) by a combination that minimizes the sum of the TDM orientation angles (θₕₒᵣ) and extraordinary refractive index (nₑ) errors.

In other words, at least one processor (105) may simultaneously determine the optimal TDM orientation angle (θₕₒᵣ) and extraordinary refractive index (nₑ) by comparing each of a plurality of second simulation images with the second image according to various combinations of TDM orientation angles (θₕₒᵣ) and extraordinary refractive indices (nₑ).

The TDM orientation angle (θₕₒᵣ) error and the extraordinary refractive index (nₑ) error can be expressed using the mean squared error (MSE), but the embodiments of the present disclosure may not be limited thereto.

According to an embodiment, the angle at which the TDM is positioned may be calculated based on Equation 1. The angle at which the TDM is positioned is determined by comparing the measured emission intensity profile (I) at pPP with a weighted sum of the intensity profile of a p-polarized dipole aligned horizontally (pPPₕₒᵣ) and the profile of a p-polarized dipole aligned vertically (pPPᵥₑᵣ).

$$I ( {k}_{‖} / {k}_{0} ) = {θ}_{hor} \cdot {I}_{pPP - hor} ( {k}_{‖} / {k}_{0} ) + ( 1 - {θ}_{hor} ) \cdot {I}_{pPP - ver} ( {k}_{‖} / {k}_{0} ) . \qquad [ Equation 1 ]$$

I(k_{∥}/k₀) may represent the magnitude of a normalized wave vector. θₕₒᵣ may represent the horizontal angle at which the TDM is placed. I_{pPP-hor}(k_{∥}/k₀) may represent the horizontal magnitude of the second polarization plane with respect to the normalized wave vector. I_{pPP-ver}(k_{∥}/k₀) represent the magnitude of the second polarization plane in the vertical direction with respect to the normalized wave vector.

According to an embodiment, at least one processor may prevent image artifacts by performing the fitting in a limited region between −1.1 and 1.1.

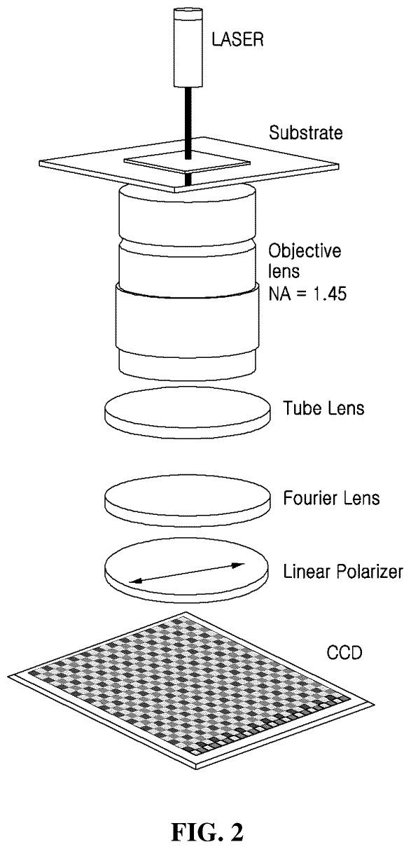

FIG. 2 illustrates an example of the structure of a thin film characteristic diagnosis device in a thin film characteristic diagnosis device and thin film characteristic diagnosis method according to an embodiment of the present document.

Referring to FIG. 2, a thin film characteristic diagnosis device (e.g., the thin film characteristic diagnosis device (101) of FIG. 1) may include a Fourier imaging microscope (FIM). For example, the thin film characteristic diagnosis device (101) may include a laser, an objective lens, a Fourier lens, a polarizer, and an image sensor. The thin film characteristic diagnosis device (101) may additionally include a filtering filter or a neutral density filter.

The thin film characteristic diagnosis device (101) may include an inverse luminescence microscope equipped with a laser for optically pumping the thin film. Emission light emitted from the thin film may be converted into spatial frequencies by a Fourier lens. The Fourier lens may map wave vector components (k∥), which vary with the angle of incidence, onto the Fourier plane. The image sensor in the Fourier plane may record these spatial frequencies.

Emission light passing through a Fourier lens may be separated into first and second polarization plane components by a polarizer. The first spectrum, obtained by polarizing the emission light according to the first polarization plane (e.g., sPP), is determined by the refractive index and may be determined independently of the angle at which the TDM of the thin film is positioned. The second spectrum, obtained by polarizing the emission light according to the second polarization plane (e.g., pPP), may be determined by the refractive index of the thin film and the angle at which the TDM is positioned. The second spectrum may be influenced by the horizontal (e.g., pPPhor) angle at which the TDMs are positioned and the vertical angle at which the TDMs are positioned.

The TDM position angle obtained from the second spectrum may be represented by θhor, which represents the proportion of the horizontal component in the total TDM position angle. θhor may range from 0 to 1, indicating a horizontally aligned TDM of 0 to 100%. If θhor=0.67, the TDMs may be randomly oriented because the contributions of the three TDM components are equal.

According to an embodiment, specifically, the Fourier imaging microscope may be composed of an inverted photoluminescence microscope and an optical component system. The inverted photoluminescence microscope may include a laser (e.g., a laser having a wavelength of approximately 405 nm (nanometer)) and an inverted microscope. The optical component system may include a Fourier lens, an optical filter, a linear polarizer, and an image sensor (e.g., a charge-coupled device (CCD) arranged in a 1024×1024 array).

According to one embodiment, light emitted from the thin film may be collected through an objective lens (e.g., an oil-immersion objective lens with a magnification of approximately 100× and a numerical aperture (NA) of approximately 1.45). Emission light passing through the Fourier lens (e.g., a Fourier lens with a focal length of approximately 300 millimeters) may reconstruct a Fourier image plane on the image sensor.

Before passing through the Fourier lens, the emission light emitted from the thin film may pass through at least one of a filtering filter that filters laser light reflected from the thin film, a neutral density (ND) filter that reduces the intensity of the emission light, or a combination thereof.

Emission light passing through the Fourier lens (e.g., a Fourier lens with a focal length of approximately 300 millimeters (mm)) and enters the image sensor, the emission light may pass through a linear polarizer. The linear polarizer may separate the incident light into two orthogonal planes corresponding to a first polarization plane and a second polarization plane. At least one processor may perform k-space fitting of the Fourier image within the range-1.1<k_{∥}/k₀<1.1.

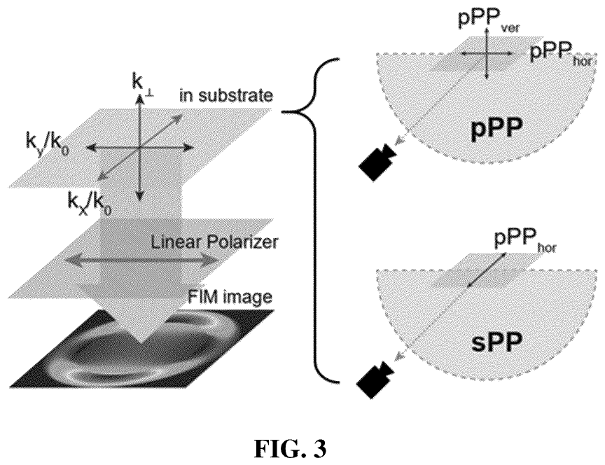

FIG. 3 illustrates examples of a first polarization plane and second polarization plane in a thin film characteristic diagnosis device and thin film characteristic diagnosis method according to an embodiment of the present document.

Referring to FIG. 3, the first polarization plane may be perpendicular to the second polarization plane. The second polarization plane may be composed of a horizontal component (pPPhor) and a vertical component (pPPver).

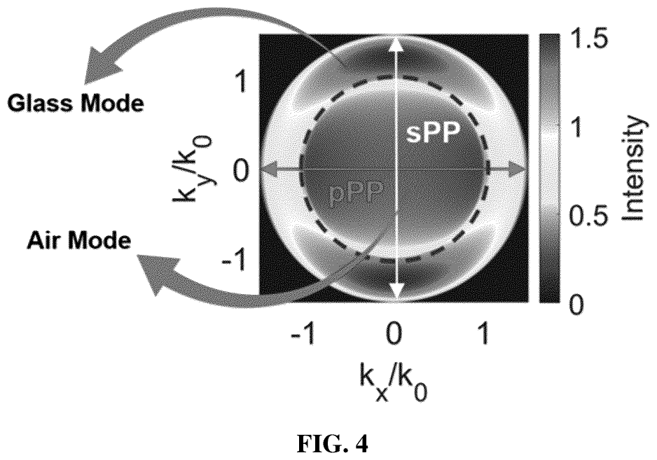

FIG. 4 illustrates an example of a polarized Fourier plane image in a thin film characteristic diagnosis device and thin film characteristic diagnosis method according to an embodiment of the present document.

Referring to FIG. 4, the Fourier plane image may represent an image that has passed through a polarizing plate after passing through a Fourier lens.

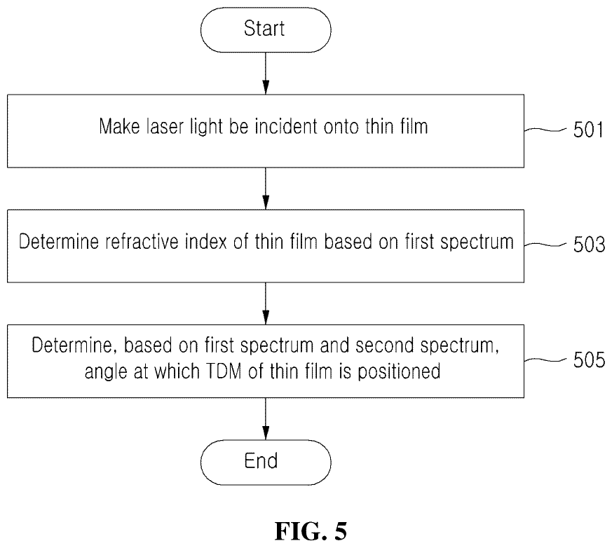

FIG. 5 illustrates an example of the flow of operations of a thin film characteristic diagnosis device that determines a refractive index and an angle at which a TDM is positioned in a thin film characteristic diagnosis device and thin film characteristic diagnosis method according to an embodiment of the present document.

Referring to FIG. 5, in a first operation (501), at least one processor of the thin film characteristic diagnosis device may make laser light be incident onto the thin film.

According to an embodiment, the laser light may supply energy to the thin film.

In a second operation (503), at least one processor of the thin film characteristic diagnosis device may determine the refractive index of the thin film based on a first spectrum.

According to an embodiment, the first spectrum may include a spectrum obtained by polarizing emission light emitted from the thin film and then passing through a Fourier lens according to a first polarization plane.

In a third operation (505), at least one processor of the thin film characteristic diagnosis device may determine the angle at which the TDM of the thin film is positioned based on the first spectrum and the second spectrum.

According to an embodiment, the second spectrum may include a spectrum obtained by polarizing emission light emitted from a thin film and then passing through a Fourier lens according to a second polarization plane perpendicular to the first polarization plane.

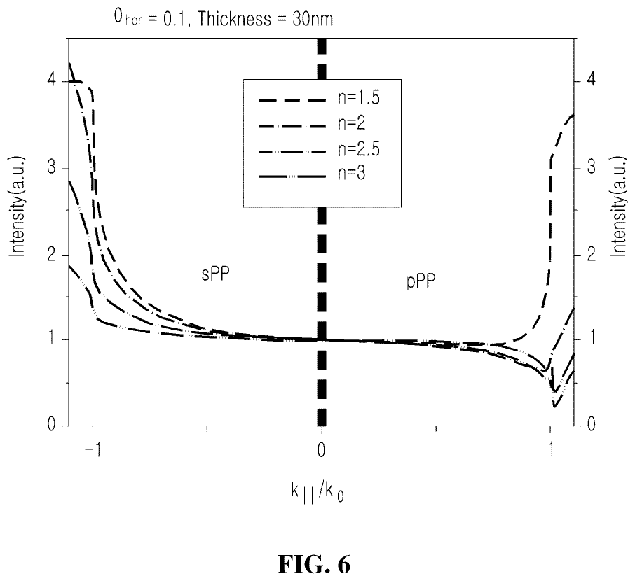

FIG. 6 illustrates the influence of a typical refractive index (n) in a monorefractive (isotropic) material without birefringence (nₒ, nₑ) in a thin film characteristic diagnosis device and thin film characteristic diagnosis method according to an embodiment of the present document, wherein shown are examples of graphs showing an intensity distribution in a first polarization plane and an intensity distribution in a second polarization plane according to the refractive indices of a thin film.

Referring to FIG. 6, when the difference between the ordinary and extraordinary refractive indices is very small or negligible (n₀≈nₑ),
while maintaining the angle at which the TDMs are positioned within the thin film (e.g., approximately 0.1) and the thickness of the thin film (e.g., approximately 30 nm (nano-meter)) constant, the intensity changes of the first spectrum according to the first polarization plane (e.g., sPP) and the intensity changes of the second spectrum according to the second polarization plane (e.g., pPP), when the refractive index is changed, may be represented. For example, as the refractive index increases from approximately 1.5 to approximately 3.0, the relative peak intensity of the first spectrum at a point in the first polarization plane (e.g., where k∥/k0=−1) may decrease by 63%.

For example, as the refractive index increases from approximately 1.5 to approximately 3.0, the relative peak intensity of the second spectrum at a point in the second polarization plane (e.g., where k∥/k0=1) may decrease by 77%. This demonstrates that the refractive index affects both the first spectrum having passed through the first polarization plane and the second spectrum having passed through the second polarization plane.

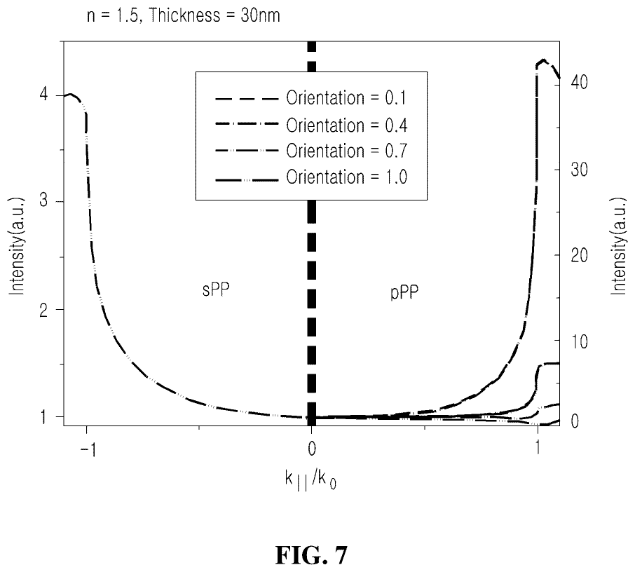

FIG. 7 illustrates examples of graphs showing an intensity distribution in a first polarization plane and an intensity distribution in a second polarization plane according to angles at which a TDM is positioned in a thin film characteristic diagnosis device and thin film characteristic diagnosis method according to an embodiment of the present document.

Referring to FIG. 7, while maintaining the refractive index of the thin film (e.g., approximately 1.5) and the thickness of the thin film (e.g., approximately 30 nm (nano-meter)) constant, the intensity change of the first spectrum according to the first polarization plane (e.g., sPP) and the intensity changes of the second spectrum according to the second polarization plane (e.g., pPP), when the refractive index is changed, may be represented. For example, as the TDM angle increases from approximately 0.1 to approximately 1.0, the relative peak intensity of the first spectrum may remain constant. For example, as the TDM angle increases from approximately 0.1 to approximately 1.0, the relative peak intensity of the second spectrum at a point in the second polarization plane (e.g., at the point where k∥/k0=1) may decrease by approximately 99.9%. Thus, it is possible to confirm that the TDM angle does not affect the first spectrum transmitted through the first polarization plane, but does affect the second spectrum transmitted through the second polarization plane.

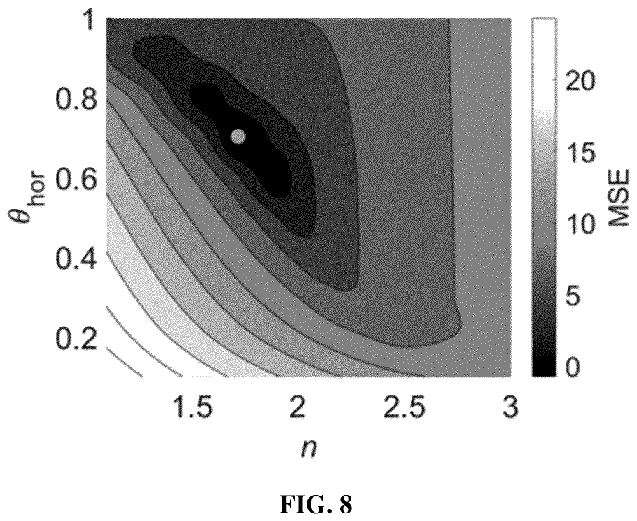

FIG. 8 illustrates examples of diagrams showing the sum of the refractive index error and the TDM error corresponding to the refractive index error, depending on the refractive indices and the angles at which a TDM is positioned, in a thin film characteristic diagnosis device and thin film characteristic diagnosis method according to an embodiment of the present document.

Referring to FIG. 8, the refractive index error may include a mean squared error (MSE) obtained by comparing a refractive index simulation image and a first image. The TDM error may include a mean squared error (MSE) obtained by comparing a second simulation image and a second image.

The diagram may represent the sum of the refractive index error and the TDM error corresponding to the refractive index error through shading.

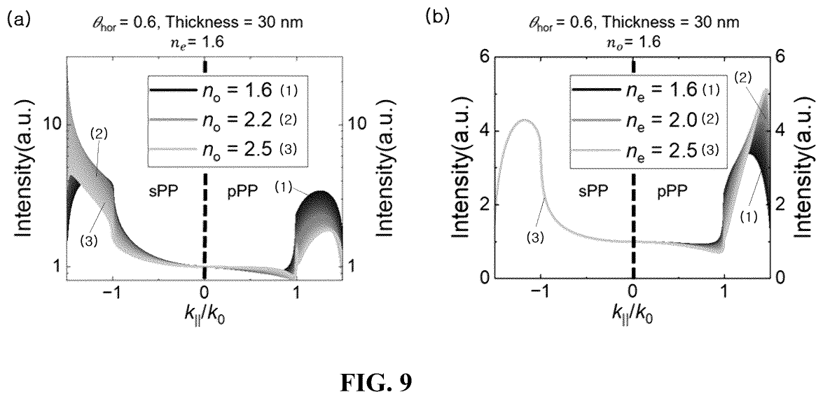

FIG. 9 illustrates the influence of each refractive index in a birefringent (nₒ, nₑ) material in a thin film characteristic diagnosis device and thin film characteristic diagnosis method according to an embodiment of the present document, wherein a of FIG. 9 is a graph depicting a k-space emission intensity distribution according to the variation of an ordinary refractive index (nₒ), and b of FIG. 9 is a graph depicting a k-space emission intensity distribution according to the variation of an extraordinary refractive index (nₑ).

Referring to a of FIG. 9, the effect of varying the ordinary refractive index (nₒ) on the sPP and pPP emission patterns may be observed while holding the TDM orientation angle θₕₒᵣ and thin film thickness constant.

As nₒ increases, the sPP pattern is transformed overall, and the pPP pattern also changes.

More specifically, when nₒ increases from 1.6 to 2.5, the relative intensity of the sPP at a specific point (k_{∥}/k₀=−1.1) decreases by 38%, and the relative intensity of the pPP at a specific point (k∥/k0=1.1) decreases by 53%.

Referring to b of FIG. 9, the effect of varying the extraordinary refractive index (nₑ) on the sPP and pPP emission patterns may be observed while holding the TDM orientation angle θₕₒᵣ and thin film thickness constant.

At this time, the sPP pattern remains constant regardless of changes in nₑ,
whereas the pPP pattern becomes increasingly sensitive to nₑ, exhibiting significant variations, particularly in the high k region (k∥/k0>1), where the out-of-plane component is maximized.

More specifically, as nₑ increases from 1.6 to 2.5, the relative intensity of sPP remains constant, while the peak intensity of pPP increases by 48%.

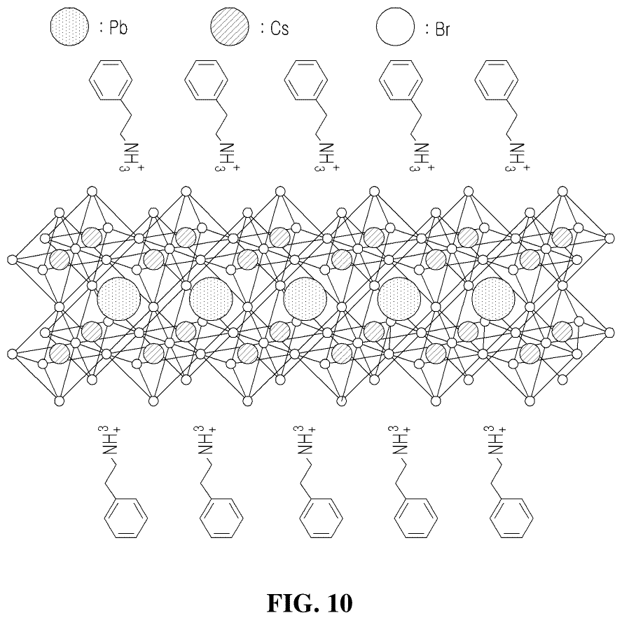

FIG. 10 illustrates the structure of an organic halide perovskite (OHP) film constituting a thin film in a thin film characteristic diagnosis device and thin film characteristic diagnosis method according to an embodiment of the present document.

Referring to FIG. 10, when a thin film according to an embodiment includes organic halide perovskite (OHP), a structure of organic halide perovskite (OHP) may be exhibited.

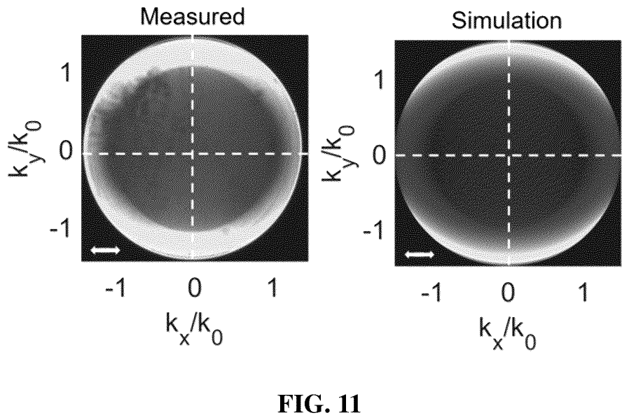

FIG. 11 illustrates examples of a Fourier plane image based on a first spectrum and a first simulation spectrum, and a Fourier plane image based on a second spectrum and a second simulation spectrum, in a thin film characteristic diagnosis device and thin film characteristic diagnosis method according to an embodiment of the present document.

Referring to FIG. 11, it is possible to confirm that, when a thin film according to an embodiment includes an organic halide perovskite (OHP) film, the accuracy of the simulation is above a standard value based on the fact that the measured Fourier plane images according to the first spectrum and the second spectrum on the left and the simulated Fourier plane images according to the first simulated spectrum and the second simulated spectrum on the right are consistent.

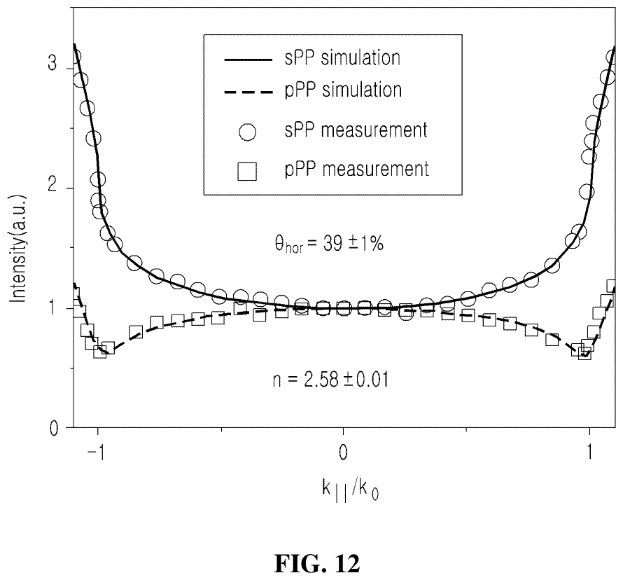

FIG. 12 illustrates an example graph showing an intensity distribution in a first polarization plane and an intensity distribution in a second polarization plane of an organic halide perovskite (OHP) film in a thin film characteristic diagnosis device and thin film characteristic diagnosis method according to an embodiment of the present document.

Referring to FIG. 12, in a thin film including an organic halide perovskite (OHP) according to one embodiment, when the sum of the refractive index error and the TDM error is a minimum value (e.g., about 0.2), the refractive index may be determined to be about 2.58±0.01, and the horizontal angle indicated by the TDM can be determined to be about 0.39±0.01.

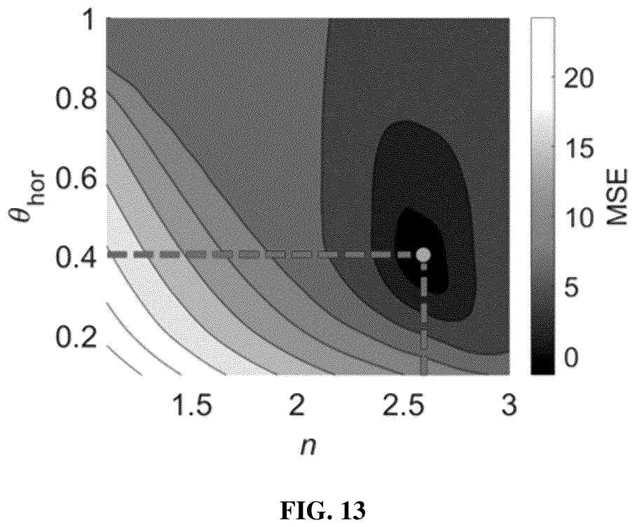

FIG. 13 illustrates an example diagram showing the sum of the refractive index error of an organic halide perovskite (OHP) film and a TDM error corresponding to the refractive index error in a thin film characteristic diagnosis device and thin film characteristic diagnosis method according to an embodiment of the present document.

Referring to FIG. 13, in a thin film including an organic halide perovskite (OHP) according to one embodiment, when the sum of the refractive index error and the TDM error is a minimum value (e.g., about 0.2), the refractive index may be determined to be about 2.58±0.01, and the horizontal angle indicated by the TDM can be determined to be about 0.39±0.01.

The sensitivity of existing techniques for measuring refractive index and TDM orientation may be lower than that of techniques for measuring refractive index and TDM orientation according to an embodiment. Furthermore, the complexity of existing techniques for measuring refractive index and TDM orientation may be higher than that of techniques for measuring refractive index and TDM orientation according to an embodiment. For example, when existing techniques for measuring refractive index and TDM orientation angle are used, materials such as organic halide perovskites (OHPs) may require measurements of reflection and transmission at various settings. The nanoscale roughness of quantum dot (QD) films may make ellipsometry refractive index modeling difficult. Consequently, existing techniques for measuring TDM orientation primarily focus on organic materials or two-dimensional materials that form smooth thin films, which may limit direct comparisons between various nanoscale light-emitting materials.

According to an embodiment, a thin film characteristic diagnosis device or thin film characteristic diagnosis method can simultaneously measure refractive index and the TDM orientation angle in a single acquisition using Fourier imaging microscopy (FIM).

According to an embodiment, a thin film characteristic diagnosis device or thin film characteristic diagnosis method can be applied to various nanomaterials because of not relying on surface interference. Furthermore, because FIM simultaneously captures emission from all angles, the thin film characteristic diagnosis device or thin film characteristic diagnosis method according to an embodiment can measure the TDM orientation angle with an accuracy higher than a reference accuracy, even in materials with a quantum efficiency lower than a reference efficiency.

According to an embodiment, a thin film characteristic diagnosis device or thin film characteristic diagnosis method can provide a method for simultaneously measuring a refractive index and TDM orientation in a single acquisition using Fourier imaging microscopy (FIM). Furthermore, according to an embodiment, a thin film characteristic diagnosis device or thin film characteristic diagnosis method can measure the refractive index and the TDM arrangement angle with a precision higher than standard precision for various nanoscale light-emitting materials. According to an embodiment, a thin film characteristic diagnosis device or thin film characteristic diagnosis method can be utilized as an important tool in designing high-performance optoelectronic devices for next-generation display technologies.

While the disclosure has been described above with reference to preferred embodiments, it will be understood by those skilled in the art or those with ordinary knowledge in the relevant technical field that various modifications and variations can be made to the disclosure without departing from the spirit and scope of the invention as set forth in the claims.

Therefore, the technical scope of the disclosure should not be limited to the details set forth in the detailed description of the specification, but should be defined by the claims.

What is claimed is:

1. A thin film characteristic diagnosis device, comprising:
a memory configured to store at least one instruction; and
at least one processor configured to execute the at least one instruction,
wherein, by executing the at least one instruction, the at least one processor is configured to:
make laser light, which supplies energy to a thin film, be incident onto the thin film;
determine an ordinary refractive index (nₒ) of the thin film based on a first spectrum obtained by polarizing emission light that has passed through a Fourier lens after being emitted from the thin film according to a first polarization plane; and
determine a transition dipole moment (TDM) orientation angle (θₕₒᵣ) and an extraordinary refractive index (nₑ) of the thin film based on the first spectrum and a second spectrum obtained by polarizing the emission light according to a second polarization plane perpendicular to the first polarization plane.

2. The thin film characteristic diagnosis device of claim 1, wherein the at least one processor is configured to:
convert the first spectrum into a first image through an image sensor;
determine the ordinary refractive index (nₒ) of the thin film based on an intensity distribution according to an angle identified based on the first image;
convert the second spectrum into a second image through the image sensor; and
determine the TDM orientation angle (θₕₒᵣ) and the extraordinary refractive index (nₑ) of the thin film based on an intensity distribution according to an angle identified based on the second image and the intensity distribution according to the angle identified based on the first image.

3. The thin film characteristic diagnosis device of claim 2, wherein
the determining the ordinary refractive index (nₒ) comprises:
setting up, through simulation, multiple simulation thin films, each of the multiple simulation thin films having a different ordinary refractive index (nₒ);
obtaining first simulation images, each of the first simulation images being converted from a first simulation spectrum in which simulated emission light that has passed through the Fourier lens after being emitted from each of the multiple simulation thin films and being polarized according to the first polarization plane;
obtaining ordinary refractive index (nₒ) errors by comparing the first image with each of the first simulation images; and
determining, as the ordinary refractive index (nₒ), a value that minimizes the ordinary refractive index (nₒ) errors, and
wherein the determining the TDM orientation angle (θₕₒᵣ) and the extraordinary refractive index (nₑ) comprises:
setting the ordinary refractive index (nₒ) to a fixed value;
setting, through simulation, multiple simulation thin films, each of the multiple simulation thin films having a different combination of the TDM orientation angle (θₕₒᵣ) and the extraordinary refractive index (nₑ);
obtaining second simulation images, each of the second simulation images being converted from a second simulation spectrum in which simulated emission light that has passed through the Fourier lens after being emitted from each of the multiple simulation thin films and being polarized according to the second polarization plane;
simultaneously obtaining TDM orientation angles (θₕₒᵣ) and extraordinary refractive index (nₑ) errors by comparing the second image with each of the second simulation images; and
simultaneously determining the TDM orientation angle (θₕₒᵣ) and the extraordinary refractive index (nₑ) by a combination that minimizes a sum of the TDM orientation angles (θₕₒᵣ) and extraordinary refractive index (nₑ) errors.

4. The thin film characteristic diagnosis device of claim 1, wherein the emission light, after being emitted from the thin film, passes through a filtering filter that filters the laser light reflected from the thin film before passing through the Fourier lens.

5. The thin film characteristic diagnosis device of claim 1, wherein the emission light, after being emitted from the thin film, passes through a neutral density (ND) filter that reduces an intensity of the emission light before passing through the Fourier lens.

6. A thin film characteristic diagnosis method, comprising:
making laser light, which supplies energy to a thin film, be incident onto the thin film;
determining an ordinary refractive index (nₑ) of the thin film based on a first spectrum obtained by polarizing emission light that has passed through a Fourier lens after being emitted from the thin film according to a first polarization plane; and
determining a transition dipole moment (TDM) orientation angle (θₕₒᵣ) and an extraordinary refractive index (nₑ) of the thin film based on the first spectrum and a second spectrum obtained by polarizing the emission light according to a second polarization plane perpendicular to the first polarization plane.

7. The thin film characteristic diagnosis method of claim 6, wherein the determining the ordinary refractive index (nₒ) comprises:
converting the first spectrum into a first image through an image sensor; and
determining the ordinary refractive index (nₒ) of the thin film based on an intensity distribution according to an angle identified based on the first image, and
wherein the determining the TDM orientation angle (θₕₒᵣ) and the extraordinary refractive index (nₑ) comprises:
converting the second spectrum into a second image through the image sensor; and
determining the TDM orientation angle (θₕₒᵣ) and the extraordinary refractive index (nₑ) of the thin film based on an intensity distribution according to an angle identified based on the second image and the intensity distribution according to the angle identified based on the first image.

8. The thin film characteristic diagnosis method of claim 7, wherein the determining the ordinary refractive index (nₒ) comprises:
setting up, through simulation, multiple simulation thin films each having a different ordinary refractive index (nₒ);
obtaining first simulation images, each of the first simulation images being converted from a first simulation spectrum in which simulated emission light that has passed through the Fourier lens after being emitted from each of the multiple simulation thin films and being polarized according to the first polarization plane;
obtaining ordinary refractive index (nₒ) errors by comparing the first image with each of the first simulation images; and
determining, as the ordinary refractive index (nₒ), a value that minimizes the ordinary refractive index (nₒ) errors, and
wherein the determining the TDM orientation angle (θₕₒᵣ) and the extraordinary refractive index (nₑ) comprises:
setting the ordinary refractive index (nₒ) to a fixed value;
setting, through simulation, multiple simulation thin films, each of the multiple simulation thin films having a different combination of the TDM orientation angle (θₕₒᵣ) and the extraordinary refractive index (nₑ);
obtaining second simulation images, each of the second simulation images being converted from a second simulation spectrum in which simulated emission light that has passed through the Fourier lens after being emitted from each of the simulation thin films and being polarized according to the second polarization plane;
simultaneously obtaining TDM orientation angles (θₕₒᵣ) and extraordinary refractive index (nₑ) errors by comparing the second image with each of the second simulation images; and
simultaneously determining the TDM orientation angle (θₕₒᵣ) and the extraordinary refractive index (nₑ) by a combination that minimizes a sum of the TDM orientation angles (θₕₒᵣ) and extraordinary refractive index (nₑ) errors.

9. The thin film characteristic diagnosis method of claim 6, wherein the emission light, after being emitted from the thin film, passes through a filtering filter that filters the laser light reflected from the thin film before passing through the Fourier lens.

10. The thin film characteristic diagnosis method of claim 6, wherein the emission light, after being emitted from the thin film, passes through a neutral density (ND) filter that reduces an intensity of the emission light before passing through the Fourier lens.
